(19) United States
(12) Patent Application Publication
(10) Pub. No.: US 2025/0085572 A1
(43) Pub. Date: Mar. 13, 2025

(54) CURVATURE DETERMINATION METHOD FOR CURVED DISPLAY PANEL, CURVED DISPLAY PANEL, AND DISPLAY DEVICE

(71) Applicants: BEIJING BOE DISPLAY TECHNOLOGY CO., LTD., Beijing (CN); BOE TECHNOLOGY GROUP CO., LTD., Beijing (CN)

(72) Inventors: You LI, Beijing (CN); Minghui ZHANG, Beijing (CN); Yanjun SUN, Beijing (CN); Zhizhong ZHANG, Beijing (CN); Yao ZHANG, Beijing (CN); Zhengang GAO, Beijing (CN); Yue GUO, Beijing (CN); Lei LIU, Beijing (CN); Dongyu LIU, Beijing (CN); Longyue GAO, Beijing (CN); Juan WANG, Beijing (CN); Zhihui JIN, Beijing (CN)

(21) Appl. No.: 18/554,785

(22) PCT Filed: Aug. 30, 2022
(86) PCT No.: PCT/CN2022/115779

§ 371 Date: Oct. 10, 2023

(51) Int. Cl. G02F 1/01; G06F 30/17; G06F 119/14

(52) U.S. Cl. CPC G02F 1/0102; G06F 30/17; G06F 2119/14

(57) ABSTRACT

The present disclosure provides a curvature determination method, a curved display panel, and a display device. The curvature determination method includes: establishing a first association relationship between deflection and a shear stress of the curved display panel in a first direction, the first direction being a bending direction of the curved display panel; determining a constraint condition for the shear stress in accordance with an influence of the shear stress on a light leakage of the curved display panel; and generating a curvature change relationship of the curved display panel in the first direction in accordance with the first association relationship when the constraint condition has been satisfied.

### TECHNICAL FIELD

The present disclosure relates to the field of display technology, in particular to a curvature determination method for a curved display panel, a curved display panel, and a display device.

### BACKGROUND

Curved display panel refers to a display panel with a curved surface, and as compared with a plane display panel, a distance between different regions of the curved display panel and eyes of a user is smaller. In addition, the curved display panel has attracted more and more attensions dues to a novel appearance. However, there exists a light leakage for the curved display panel, so the user experience is adversely affected.

### SUMMARY

An object of the present disclosure is to provide a curvature determination method for a curved display panel, a curved display panel, and a display device, so as to improve the user experience.

In one aspect, the present disclosure provides in some embodiments a curvature determination method for a curved display panel, including: establishing a first association relationship between deflection and a shear stress of the curved display panel in a first direction, the first direction being a bending direction of the curved display panel; determining a constraint condition for the shear stress in accordance with an influence of the shear stress on a light leakage of the curved display panel; and generating a curvature change relationship of the curved display panel in the first direction in accordance with the first association relationship when the constraint condition has been satisfied.

In a possible embodiment of the present disclosure, the establishing the first association relationship between the deflection and the shear stress of the curved display panel in the first direction includes: obtaining a second association relationship between the shear stress and a cross-sectional shear force of the curved display panel in the first direction; obtaining a third association relationship between the deflection and a bending moment of the curved display panel in the first direction; obtaining a fourth association relationship among the deflection, the cross-sectional shear force and the bending moment of the curved display panel in the first direction; and generating the first association relationship in accordance with the second association relationship, the third association relationship and the fourth association relationship.

In a possible embodiment of the present disclosure, the constraint condition includes that the shear stress is a constant.

In a possible embodiment of the present disclosure, the curved display panel further includes a second edge extending along a second direction, and the second direction intersects the first direction. The curvature determination method further includes: determining an initial stress distribution state of the second edge in accordance with the curvature change relationship; determining a fitted shape of the second edge in accordance with the initial stress distribution state and a support mode of the second edge; and determining a support parameter of the second edge in accordance with the fitted shape of the second edge.

In a possible embodiment of the present disclosure, the determining the support parameter of the second edge in accordance with the fitted shape of the second edge includes: establishing a model of the curved display panel in accordance with the determined fitted shape; determining a stress distribution state of the second edge in different support states through simulation; and determining the support parameter of the second edge in accordance with the support state corresponding to a simulation result when the stress distribution state satisfies a preset stress distribution requirement.

In a possible embodiment of the present disclosure, the support parameter includes a support position and a support length for the second edge.

In a possible embodiment of the present disclosure, the fitted shape includes an arc-like shape.

In another aspect, the present disclosure provides in some embodiments a curved display panel having a curvature determined by the above-mentioned curvature determination method.

In yet another aspect, the present disclosure provides in some embodiments a display device including the above-mentioned curved display panel.

In still yet another aspect, the present disclosure provides in some embodiments a curved display panel. A curvature w of a first edge of the curved display panel in a first direction satisfies

$$w = {k}_{1} {x}^{3} + {k}_{2} x , 0 \leq x \leq L / 2 ,$$

$$and$$

$$w = - {k}_{1} {( x - L )}^{3} - {k}_{2} ( x - L ) , L / 2 < x \leq L ,$$

$$where$$

$${k}_{1} = \frac{- 8 {w}_{max}}{2 {L}^{3}} ,$$

$${k}_{2} = \frac{3 {w}_{max}}{L} ,$$

L is a dimension of the curved display panel along the first direction, wₘₐₓ is a maximum deflection value of the curved display panel, and the first direction is a bending direction of the curved display panel.

In a possible embodiment of the present disclosure, the curved display panel further includes a second edge extending along a second direction, and the second direction intersects the first direction. A curvature w₁ of the second edge satisfies w₁=\sqrt{R²−(y−O₂)²}−O₁, where R is a radius, and O₁ and O₂ are each coordinates of a center of a circle.

In a possible embodiment of the present disclosure, the curved display panel further includes a second edge extending along a second direction, the second direction intersects the first direction, and both ends of the second edge are bent toward a side away from a light- exiting surface of the curved display panel.

In a possible embodiment of the present disclosure, two endpoints of the second edge are bent with respect to a middle point of the second edge by 0.4 mm to 1.5 mm.

In a possible embodiment of the present disclosure, the curved display panel further includes a support structure abutting against the second edge of the curved display panel, a middle point of the second edge is arranged in a region where the support structure abuts against the second edge, and a length of the support structure is 20% to 42% of a length of the second edge.

In a possible embodiment of the present disclosure, the length of the support structure is 30% to 36% of the length of the second edge.

In a possible embodiment of the present disclosure, a middle point of the support structure corresponds to the middle point of the second edge, and the support structure is arranged symmetrically relative to a central axis of the second edge.

In a possible embodiment of the present disclosure, the middle point of the support structure is located between the middle point of the second edge and a top endpoint of the second edge.

In a possible embodiment of the present disclosure, the second edge extends along a straight line in the region where the support structure abuts against the second edge; and/or a bending amount of the second edge toward a side away from a light-exiting surface of the curved display panel gradually increases between each of two ends of the support structure and a corresponding endpoint of the second edge.

In a possible embodiment of the present disclosure, a bending amount of the second edge gradually increases toward a side away from a light-exiting surface of the curved display panel in a direction from the middle point of the second edge to each endpoint of the second edge, and a shape of the support structure matches a shape of the second edge.

### BRIEF DESCRIPTION OF THE DRAWINGS

In order to illustrate the technical solutions of the present disclosure in a clearer manner, the drawings desired for the present disclosure will be described hereinafter briefly. Obviously, the following drawings merely relate to some embodiments of the present disclosure, and based on these drawings, a person skilled in the art may obtain the other drawings without any creative effort.

FIG. 1 is a flow chart of a curvature determination method for a curved display panel according to one embodiment of the present disclosure;

FIG. 2 is a schematic view showing a phase retardation according to one embodiment of the present disclosure;

FIG. 3A is a schematic view of a display device according to one embodiment of the present disclosure;

FIG. 3B is a schematic view showing stress distribution of the curved display panel according to one embodiment of the present disclosure;

FIG. 4A is a schematic view showing a force applied to the curved display panel according to one embodiment of the present disclosure;

FIG. 4B is a schematic view showing a shear force of the curved display panel in FIG. 4A;

FIG. 5A is a simulation view of a stress of a conventional curved display panel;

FIG. 5B is a schematic view showing an operating state of the conventional curved display panel;

FIG. 6 is a schematic view showing of a constraint condition according to one embodiment of the present disclosure;

FIG. 7 is a schematic view showing a shape of a first edge of the curved display panel according to one embodiment of the present disclosure;

FIG. 8 is a schematic view showing a support state of a second edge of the curved display panel according to one embodiment of the present disclosure;

FIG. 9A is a schematic view showing the distribution of a support force for a second edge of the conventional curved display panel;

FIG. 9B is a schematic view showing the distribution of a support force distribution for a second edge of the curved display panel according to one embodiment of the present disclosure;

FIG. 9C is another schematic view showing the distribution of the support force for the second edge of the conventional curved display panel;

FIG. 10 is a schematic view showing deflection of the second edge of the curved display panel according to one embodiment of the present disclosure;

FIG. 11A is a schematic view showing a simulation result of the second edge of the curved display panel according to one embodiment of the present disclosure;

FIG. 11B is a topical schematic view showing the simulation result of the second edge of the curved display panel according to one embodiment of the present disclosure;

FIG. 12 is a schematic view showing a relationship between a shear stress of the curved display panel and a support length of the second edge according to one embodiment of the present disclosure;

FIG. 13A is a simulation view of a stress of the curved display panel according to one embodiment of the present disclosure; and

FIG. 13B is a schematic view showing an operating state of the curved display panel according to one embodiment of the present disclosure.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Such words as “first” and “second” involved in the specification and the appended claims are merely used to differentiate different objects rather than to represent any specific order. In addition, such words as “include” or “including” or any other variations involved in the present disclosure intend to provide non-exclusive coverage, so that a procedure, method, system, product or device including a series of steps or units may also include any other elements not listed herein, or may include any inherent steps or units of the procedure, method, system, product or device. In addition, the expression “and/or” in the description and the appended claims is merely used to represent at least one of the objects before and after the expression. For example, “A and/or B and/or C” represents seven situations, i.e., there is only A, there is only B, there is only C, there are both A and B, there are both B and C, thereby are both A and C, and there are A, B and C.

The present disclosure provides in some embodiments a curvature determination method for a curved display panel.

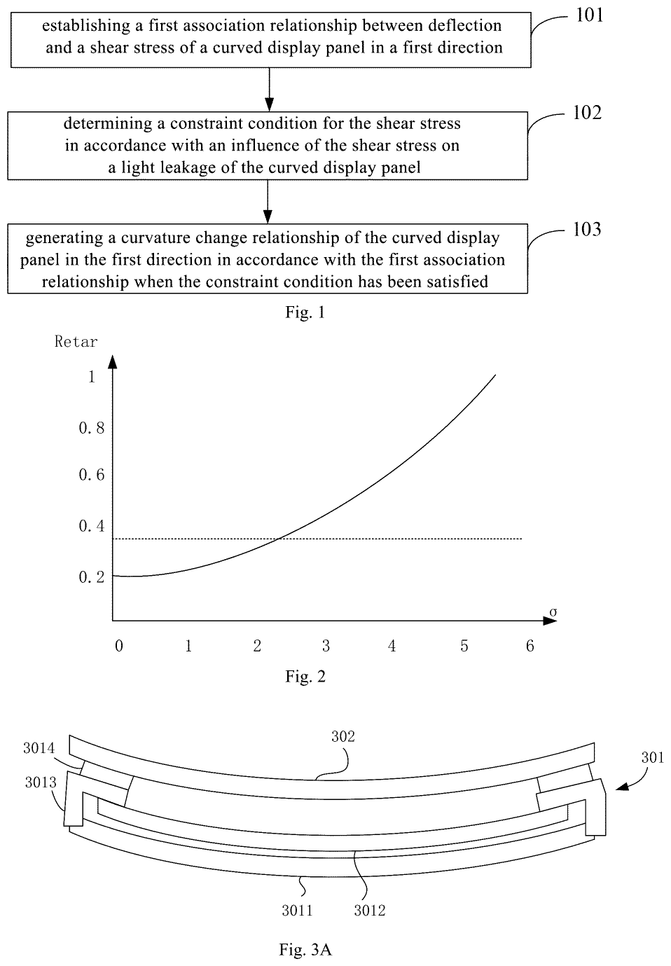

As shown in FIG. 1, the method includes the following steps.

Step 101: establishing a first association relationship between deflection and a shear stress of the curved display panel in a first direction, the first direction being a bending direction of the curved display panel.

F. Neumann and J. C. Maxwell studied a birefringence theory of a transparent medium under the effect of any force system, and discovered the stress-optical law, i.e., directions of three principal stresses or principal strains at any point in an elastomer with a birefringence effect coincide with directions of three principal refractive indices at the point respectively. The principal strain at any point in the elastomer is in direct proportion to a change in the principal refractive index at the point caused by deformation. This law is expressed as

$${n}_{1} - {n}_{2} = A ( {σ}_{1} - {σ}_{2} ) , {n}_{2} - {n}_{3} = A ( {σ}_{2} - {σ}_{3} ) \cdot {n}_{3} - {n}_{1} = A ( {σ}_{3} - {σ}_{1} ) , \qquad ( 1 )$$

where n1, n2 and n3 are principal refractive indices whose directions are consistent with directions of σ1, σ2 and σ3 after a material has been deformed (e.g., n1, n2 and n3 are principal refractive indices in an x-axis direction, a y-axis direction and a z-axis direction respectively in a three-dimensional rectangular coordinate system, and σ1, σ2 and σ3 are positive stresses in the x-axis direction, y-axis direction and z-axis direction respectively), and A may be understood as a stress optical coefficient of the material. To be specific, the stress optical coefficient is a difference between a longitudinal stress optical constant and a transverse stress optical constant of the material, and it is a constant determined in accordance with properties of the material.

As shown in FIG. 2, based on (1), the stress applied onto a medium causes a change in the refractive index on each principal axis. Propagation speeds of light in media with different refractive indices are different, so a birefringence phenomenon occurs and a phase retardation is generated. The phase retardation is expressed as

$${R}_{etar} = σ * h * C , \qquad ( 2 )$$

where Rₑₜₐᵣ is the phase retardation caused by the stress, C is a preset constant, h is a thickness of the medium, and σ is the positive stress.

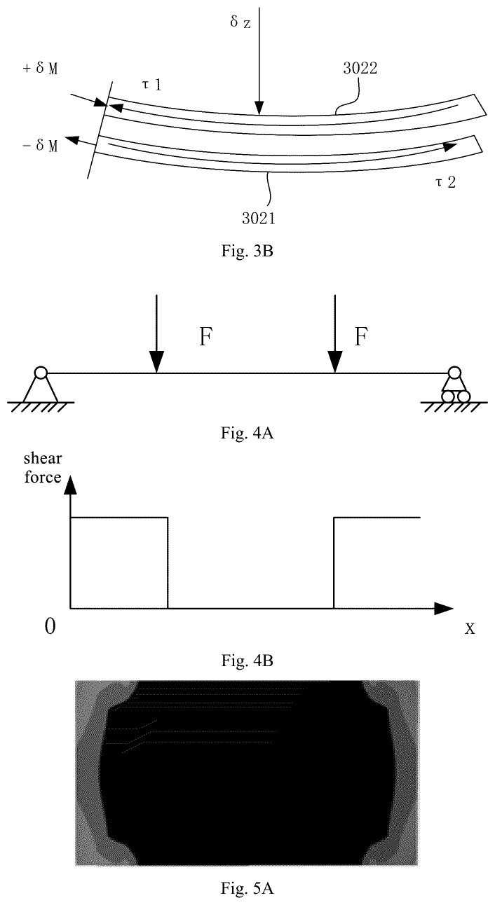

As shown in FIG. 3A, a display device includes a back plate module 301 and a curved display panel 302. The back plate module 301 includes a housing 3011, a backlight module 3012, a support 1013, etc. During the implementation, the structure of the back plate module 301 is set in accordance with the practical needs. Further, as shown in FIG. 3B, in some embodiments of the present disclosure, the curved display panel 302 includes an array substrate 3021 and a color film substrate 3022 arranged opposite to each other to form a cell.

As shown in FIG. 3B, there exist three stresses when the curved display panel is bent, i.e., a positive stress δz, a bending stress δM, and a shear stress τ.

A direction of the positive stress is perpendicular to an extension direction of a polarization axis of a polarizer, so it is impossible for polarized light to pass through the polarizer. A sum of the bending stresses is zero in a cross section, i.e., the bending stresses cancel out each other. A direction of the shear stress is parallel to the extension direction of the polarization axis of the polarizer, and it may penetrate through the polarizer. Hence, a light leakage is mainly caused due to the shear stress.

In the embodiments of the present disclosure, the first association relationship between the deflection and the shear stress of the curved display panel in the first direction is established at first.

In the embodiments of the present disclosure, the first direction is a bending direction of the curved display panel. When the display panel is of a rectangular shape, the display panel includes a first edge L1 and a second edge L2. Here, the first edge L1 refers to a relatively long edge of the display panel in the first direction, also referred to as a length direction of the display panel, and the second edge L2 refers to a relatively short edge of the display panel in the second direction, also referred to as a height or width direction of the display panel. Generally, the display panel is bent along the length direction, i.e., the first edge L1 is bent so that a surface of the display panel is curved.

It should be appreciated that, in the coordinate system established in the embodiments of the present disclosure, a length direction of a long side of the curved display panel is taken as the x-axis direction, a length direction of a short side of the curved display panel is taken as the y-axis direction, and a thickness direction of the curved display panel is taken as the z-axis direction.

Based on the above analysis, the light leakage is mainly caused by the shear stress. Hence, in the embodiments of the present disclosure, the relationship between the shear stress and the deflection of the display panel in the first direction is established to optimize the curvature of the display panel.

In a possible embodiment of the present disclosure, Step 101 specifically includes: obtaining a second association relationship between the shear stress and a cross-sectional shear force of the curved display panel in the first direction; obtaining a third association relationship between the deflection and a bending moment of the curved display panel in the first direction; obtaining a fourth association relationship among the deflection, the cross-sectional shear force and the bending moment of the curved display panel in the first direction; and generating the first association relationship in accordance with the second association relationship, the third association relationship and the fourth association relationship.

In the embodiments of the present disclosure, the curved display panel is of a typical plate structure, and it is considered that the display panel is bent to a same extent at a same position in the second direction, so the curved display panel is analyzed as a beam structure so as to simplify the calculation.

When the second direction is taken as the x-axis direction and the thickness direction of the curved display panel is taken as the z-axis direction, the second association relationship between the shear stress and the cross-sectional shear force of the curved display panel is expressed as

$$τ = \frac{V}{2 I} ( \frac{{h}^{2}}{4} - {z}^{2} ) , \qquad ( 3 )$$

where τ is the shear stress, V is the cross-sectional shear force, I is an inertia moment of a cross section of the curved display panel perpendicular to the first direction, h is the thickness of the curved display panel, and z is coordinates in the thickness direction of the curved display panel. An origin in the thickness direction is a middle point in the thickness direction of the curved display panel.

As shown in FIG. 4A, in a possible embodiment of the present disclosure, a force F is applied by a fixation structure to the curved display panel in a direction perpendicular to a surface of the curved display panel, and FIG. 4B shows the distribution of the shear force.

It should be appreciated that, when the curved display panel is curved, a plurality of fixation structures is used for constraints. In general, the fixation structures are symmetrically distributed. Hence, in the embodiments of the present disclosure, the curved display panel is further equivalent to a simply-supported beam structure, so as to simplify the calculation.

In a possible embodiment of the present disclosure, the third association relationship between the deflection and the bending moment of the curved display panel is expressed as

$$\frac{{d}^{2} w}{{dx}^{2}} = \frac{M ( x )}{EI} , \qquad ( 4 )$$

where w is the deflection, M(x) is the bending moment at coordinates x, an origin is one end in the first direction, and E is an elastic modulus of the curved display panel in the x-axis direction.

Next, the fourth association relationship among the deflection, the cross-sectional shear force and the bending moment of the curved display panel is determined through

$$V = \frac{dM ( x )}{dx} . \qquad ( 5 )$$

(3) and (4) are substituted into (5) so as to obtain

$$\frac{{d}^{3} w}{{dx}^{3}} = \frac{8 τ}{E ( {h}^{2} - 4 {z}^{2} )} . \qquad ( 6 )$$

Since the thickness of the curved display panel is relatively small with respect to the dimension in the first direction, the change in the shear stress within the thickness range may be ignored. Hence, z is equal to 0 so as to simplify the calculation. At this time, (6) is simplified to

$$\frac{{d}^{3} w}{{dx}^{3}} = \frac{8 τ}{{Eh}^{2}} . \qquad ( 7 )$$

In this way, it is able to establish the first association relationship between the deflection and the shear stress in the first direction.

Step 102: determining a constraint condition for the shear stress in accordance with an influence of the shear stress on a light leakage of the curved display panel.

Based on the above, the light leakage is caused by the concentration of the shear stresses. In order to prevent the occurrence of the light leakage, it is necessary to reduce or prevent the occurrence of stress concentration.

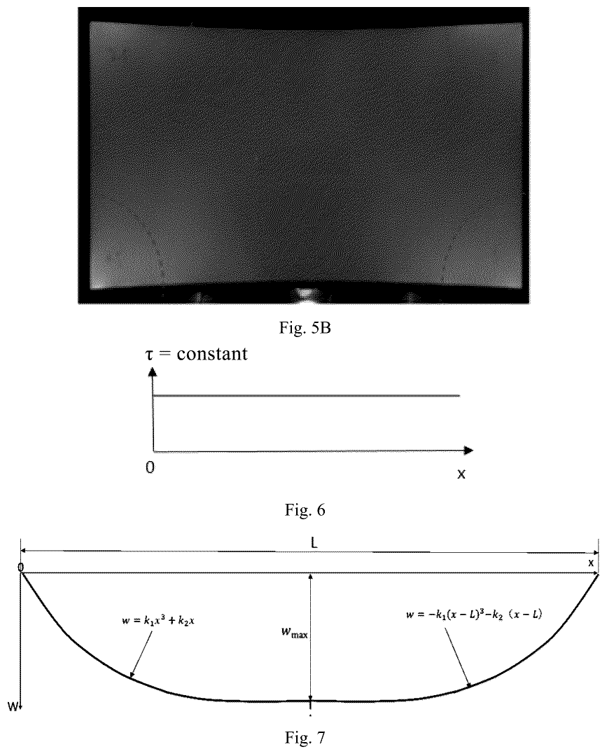

As shown in FIG. 5A, through simulation of a conventional curved display panel, it is found that the stress concentration mainly occurs at four vertices, where the shear stress at a position with a lighter color is larger. Further, as shown in FIG. 5B, the light leakage indeed occurs at the four vertices of the conventional curved display panel.

In some embodiments of the present disclosure, the constraint condition includes that a maximum value of the shear stress is less than a predetermined shear stress threshold.

In a possible embodiment of the present disclosure, as shown in FIG. 6, the constraint condition is defined as that the shear stress τ is a constant. In this way, it is able to prevent the occurrence of the stress concentration, and further simplify the calculation.

Step 103: generating a curvature change relationship of the curved display panel in the first direction in accordance with the first association relationship when the constraint condition has been satisfied.

When the shear stress τ is a constant, (7) is integrated so as to obtain

$$\frac{{d}^{2} w}{{dx}^{2}} = \int \frac{8 τ}{{Eh}^{2}} dx + a , \qquad ( 8 )$$

$$\frac{dw}{dx} = \int \int \frac{8 τ}{{Eh}^{2}} dx + ax + b and \qquad ( 9 )$$

$$w = \int \int \int \frac{8 τ}{{Eh}^{2}} dx + {ax}^{2} + bx + c , \qquad ( 10 )$$

where a, b and c are integration coefficients and are constants.

Based on (4), when a boundary condition is x=0, M(x)=0, and when x=0, w=0.

The determined boundary condition is substituted into (8) through (10), so as to obtain

$$w = \int \int \int \frac{8 τ}{{Eh}^{2}} dx + bx = \frac{8 τ}{{Eh}^{2}} {x}^{3} + bx . \qquad ( 11 )$$

$$Let {k}_{1} = \frac{8 τ}{{Eh}^{2}} , {k}_{2} - b , then$$

$$w = {k}_{1} {x}^{3} + {k}_{2} x , \qquad ( 12 )$$

where k₁ and k₂ are coefficient constants. In other words, in the embodiments of the present disclosure, a cubic function including a first order term and a third order term is finally determined as a curvature optimization result for the first edge L1.

In the embodiments of the present disclosure, the coefficient constants k₁ and k₂ in a curvature formula of the display panel is further determined in accordance with the design requirement.

Through taking the derivative of (13), it is able to obtain

$${w}^{′} = 3 {k}_{1} {x}^{2} + {k}_{2} . \qquad ( 13 )$$

As shown in FIG. 7, for the curved display panel, the deflection reaches a maximum of wₘₐₓ at a central position. The curvature of the display panel varies continuously, i.e., a deflection equation of the display panel is continuous and derivable at the central position of the display panel.

In this way, when the boundary condition is x=L/2, w=wₘₐₓ, and when x=L/2, w′=0.

Referring to FIG. 7, L is the length of the display panel in the first direction and wₘₐₓ is the maximum deflection value of the display panel. Both values are design values for the display panel and are known constants.

The boundary condition is substituted into (12) and (13) so as to obtain

$${k}_{1} = \frac{- 8 {w}_{max}}{2 {L}^{3}} , {k}_{2} = \frac{3 {w}_{max}}{L} .$$

Based on design parameters of the curved display panel, L and wₘₐₓ are known, so it is able to obtain the curvature equation for the display panel at a left half part in the coordinate system shown in FIG. 7.

Further, the right half part of the display panel is symmetrical with the left half part, so the curvature equation of the display panel is determined as follows through coordinate translation:

$$w = {k}_{1} {x}^{3} + {k}_{2} x , 0 \leq x \leq L / 2 , \qquad ( 14 )$$

$$w = - {{k}_{1} ( x - L )}^{3} - {k}_{2} ( x - L ) , L / 2 < x \leq L .$$

TABLE 1
coefficient constants of curved display panel

| | | Radius of | | | |
|---|---|---|---|---|---|
| | | curved | Maximum | | |
| Dimension | Length | surface | deflectionwₘₐₓ | | |
| (inch) | L(mm) | (mm) | (mm) | k₁ | k₂ |
| 34 | 812.1 | 3800 | 21.8 | 0.00000016281 | −0.08053 |
| 34 | 812.1 | 1900 | 43.9 | 0.00000032787 | −0.16217 |
| 27 | 608.1 | 3800 | 12.2 | 0.00000021701 | −0.12086 |
| 27 | 608.1 | 1900 | 24.5 | 0.00000043581 | −0.12086 |
| 23.8 | 534.8 | 3800 | 9.4 | 0.00000024581 | −0.05273 |
| 23.8 | 534.8 | 1900 | 18.9 | 0.000000494251 | −0.106021 |

As shown in Table 1, for a curved display panel with different design requirements, the corresponding coefficient constants k₁ and k₂ are calculated so as to determine the curvature of the curved display panel.

In some embodiments of the present disclosure, considering errors caused by such factors as actual fabrication and assembly, a certain margin is provided. For example, a redundancy coefficient k is set, a value of k is approximately equal to 1. To be specific, when the margin is 3%, k=±3%. During the implementation, the margin is k*w=3% w, i.e., a tolerance of 3% between an actual curvature and the curvature w calculated through (14) is allowed. In actual use, the value of the redundancy coefficient k is set according to the practical need, so as to be adapted to various errors.

In some embodiments of the present disclosure, the curved display panel further includes a second edge L2 extending in a second direction. The method further includes: determining an initial stress distribution state of the second edge in accordance with the curvature change relationship; determining a fitted shape of the second edge in accordance with the initial stress distribution state and a support mode of the second edge; and determining a support parameter of the second edge in accordance with the fitted shape of the second edge.

It is found through researches that, the light leakage does not occur in the middle of the second edge L2 of the curved display panel after the curved display panel has been bent. A simulation result of the curved display panel shows that, based on the initial stress distribution state of the second edge L2 of the curved display panel, the shear stress is smaller in the middle, and larger at two sides, so the stress concentration easily occurs.

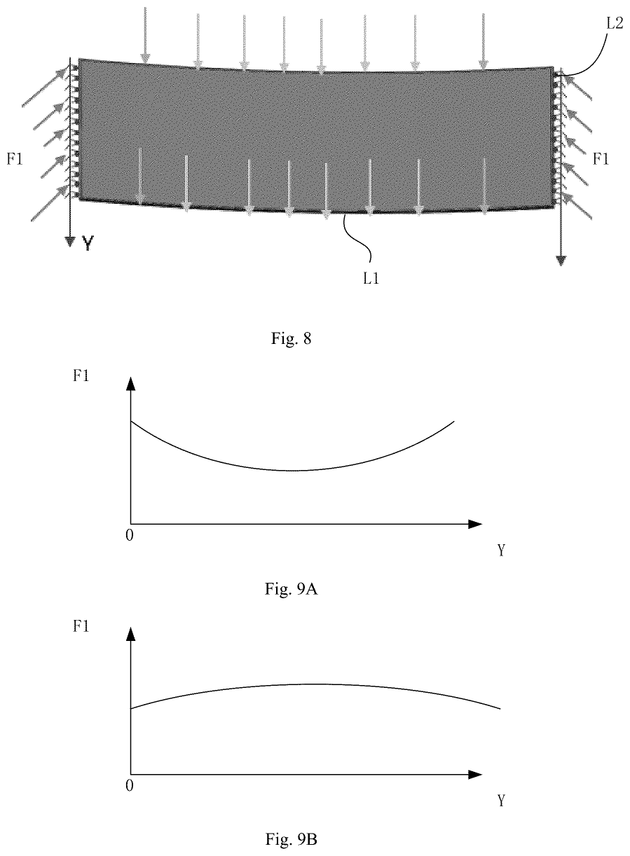

As shown in FIG. 8, it is found through analysis that, the reason for this phenomenon is that a tensile stress is applied to both ends of the second edge L2 at the two first edges L1 of the curved display panel, and a tensile stress in the middle of the curved display panel is small.

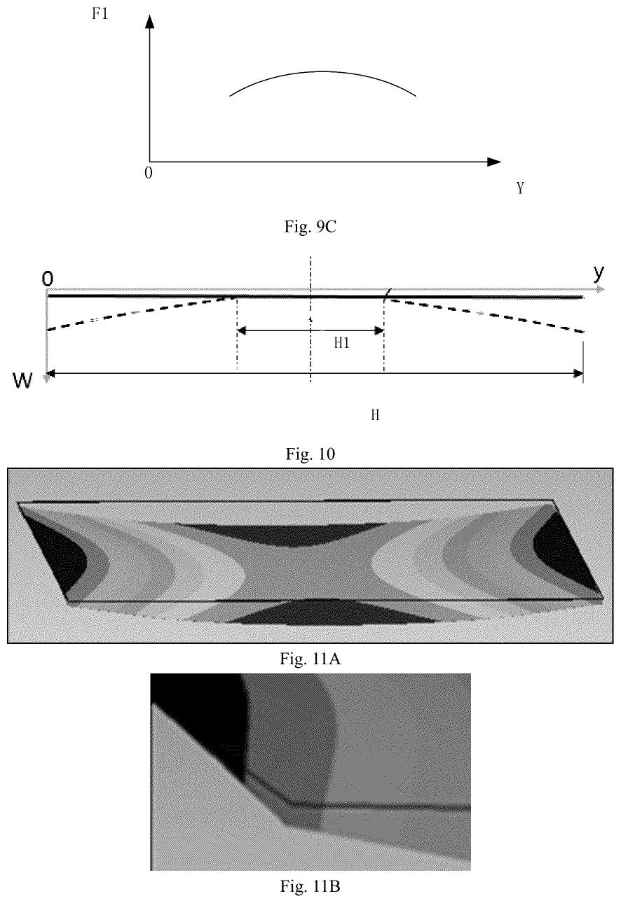

As shown in FIG. 9A, in the related art, the supporting force F1 at the second edge L2 is small in the middle and relatively large at both ends, which results in more obvious stress concentration at both ends of the second edge L2.

In the embodiments of the present disclosure, as an optimization scheme, the supporting force F1 in the middle of the second edge L2 is increased and the supporting force F1 at both ends of the second edge L2 is decreased.

As shown in FIG. 9B, in some embodiments of the present disclosure, the support force gradually decreases in a direction from the center to each end of the second edge L2.

Further, as shown in FIG. 9C, in some embodiments of the present disclosure, no supporting force is applied to both ends of the second edge L2.

In some embodiments of the present disclosure, the support force is applied along the second edge L2 and distributed symmetrically relative to the center of the second edge L2. Obviously, the curved display panel is slightly deformed in case that the support force is increased in the middle.

As shown in FIG. 10, in the embodiments of the present disclosure, both ends of the second edge L2 are bent with respect to the center in a direction away from a light-exiting surface of the curved display panel, so the second edge L2 is of a curved shape with the center protruding forward and both ends being depressed. Here, when the center of the second edge protrudes forward, it means that the center protrudes in a direction in front of the curved display panel, i.e., toward a viewer.

Through controlling both ends of the second edge L2 to be bent backward, it is able to reduce a pressure at both ends of the second edge L2, i.e., the four vertices of the curved display panel.

In some embodiments of the present disclosure, two endpoints of the second edge L2 are bent with respect to a middle point of the second edge by 0.4 mm to 1.5 mm.

The dotted line in FIG. 10 is the curved second edge L2, and a direction opposite to a w-axis direction in FIG. 10 is a direction in which light exits the display panel. Since a w coordinate value of the middle point of the second edge L2 is 0, a w coordinate value of each of the two endpoints of the second edge L2 is a bending amount of the endpoint of the second edge L2. In the embodiments of the present disclosure, through controlling the two endpoints of the second edge L2 to be bent by 0.4 mm to 1.5 mm, it is able to reduce the stress concentration at the endpoints, and prevent the generated of an additional tensile stress when the second edge is bent too much.

In some embodiments of the present disclosure, the bending amount is controlled to be 0.4 mm to 0.6 mm, e.g., 0.5 mm, so as to achieve appropriate stress distribution, and reduce the light leakage caused due to the stress concentration.

FIG. 11A shows the curved display panel, and FIG. 11B is an enlarged view of a vertex at a lower left corner of the curved display panel in FIG. 11A. As shown in FIGS. 11A and 11B, the display panel is depressed at the vertex.

During the implementation, a curve with a symmetric shape, such as a parabola or a circle, is used as a fitted shape of the second edge L2.

For example, the fitted shape includes an arc-like shape, i.e., the second edge L2 is a part of a circle.

Illustratively, an equation for a circle where the second edge L2 is located is

$${( {w}_{1} + {O}_{2} )}^{2} + {( y - {O}_{1} )}^{2} = {R}^{2} , \qquad ( 15 )$$

and based on (15),

$${w}_{1} = \sqrt{{R}^{2} - {( y - {O}_{1} )}^{2}} - {O}_{2} \qquad ( 16 )$$

is obtained, where w₁ is a curvature of the second edge L2, R is a radius of the circle, and O₁ and O₂ are coordinates of a center of the circle. During the implementation, (15) or (16) is defined as a corresponding part of the second edge L2 through adding a domain of definition.

In (15) and (16), R and the center of the circle satisfy

$$R = \frac{{O}_{1}^{2} + {Δ}^{2}}{2 Δ} ; {O}_{1} = ( {L}_{2} - H ) / 2 ; {O}_{2} = \frac{L}{2} ; H = {k}_{3} * {L}_{2} , \qquad ( 17 )$$

where Δ is a depression amount at the vertex of the display panel, i.e., the maximum deflection of the second edge L2, k₃ is a preset coefficient, and a value of k₃ is 20% to 45%.

After determining the fitted shape, the support mode for the second edge L2 is determined in accordance with the fitted shape used.

For example, the support parameters of the second edge L2 are determined through simulation.

In some embodiments of the present disclosure, the determining the support parameter of the second edge L2 in accordance with the fitted shape of the second edge L2 includes: establishing a model of the curved display panel in accordance with the determined fitted shape; determining a stress distribution state of the second edge L2 in different support states through simulation; and determining the support parameter of the second edge L2 in accordance with the support state corresponding to a simulation result when the stress distribution state satisfies a preset stress distribution requirement.

In a possible embodiment of the present disclosure, the model of the curved display panel is established through modeling simulation software, and then different constraint conditions are applied by in a simulation test, so as to determine a simulation result of the curved display panel.

For example, a finite element analysis method is selected for the simulation of the curved display panel. During the implementation, the model of the curved display panel is established in accordance with the fitted shape, and then the model is divided into a plurality of grids for the finite element analysis, so as to obtain fore and back analysis results of the curved display panel.

The obtained simulation analysis result includes the stress distribution state of the second edge L2. The support state is adjusted continuously in accordance with the obtained simulation result, and then the simulation is performed again, as shown in FIG. 10. The adjustment is performed continuously and iteratively until the stress distribution state satisfies the preset stress distribution requirements.

In some embodiments of the present disclosure, the support parameters adjusted in the simulation include a support position and a support length of the second edge L2.

For example, when the support force needs to be increased at the center of the second edge L2 based on the above, the second edge L2 is supported at the center. The support length refers to a region of the second edge L2 in which the support force is applied.

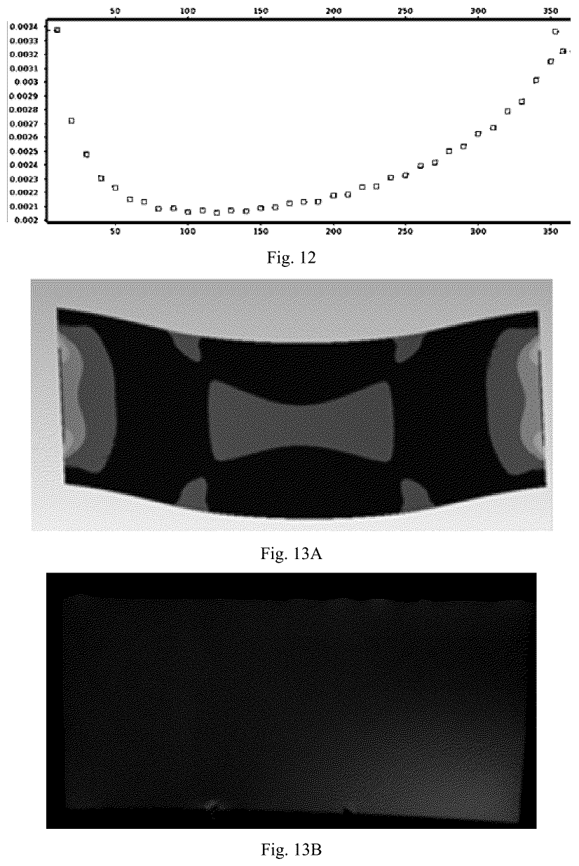

As shown in FIGS. 10 to 12, in some embodiments of the present disclosure, through the simulation and testing, a support structure abuts against the curved display panel at the second edge L2. The support structure extends from the center of the second edge L2 along the second edge L2 to both ends of the second edge L2, and a maximum distance between the support structure and the center of the second edge L2 is 10% to 21% of the length of the second edge L2.

In a possible embodiment of the present disclosure, the middle point of the second edge L2 is arranged in the region where the support structure abuts against the second edge L2, i.e., the support structure is arranged approximately in the middle of the second edge L2, rather than being aligned with the endpoints of the second edge L2.

In some embodiments of the present disclosure, a middle point of the support structure corresponds to the middle point of the second edge L2, i.e., a position of the middle point of the support structure corresponds to a position of the middle point of the second edge L2. In this way, the support structure is arranged symmetrically on both sides of the central axis of the second edge L2 with respect to a central axis of the second edge L2. A total length of the support structure is 20% to 42% of the total length of the second edge L2, so a length of a portion of the support structure on each side of the central axis of the second edge L2 is 10% to 21% of the total length of the second edge L2.

As shown in FIG. 10, a dimension of the second edge L2 is H, the support length is H1, and the support length H1 is 20% to 42% of the length H of the second edge L2.

In some embodiments of the present disclosure, the support length H1 is 30% to 36% of the length H of the second edge L2, i.e., the support force is applied to the second edge L2 at each side from the center to a position spaced apart from the center by a distance of 15% to 18% of the total length of the second edge L2. In this way, the shear stress of the second edge L2 is distributed uniformly, so as to prevent the occurrence of the stress concentration for the second edge L2, especially at the four vertices of the curved display panel, and prevent the occurrence of light leakage, thereby to improve a display effect.

In another possible embodiment of the present disclosure, the middle point of the support structure is located between the middle point of the second edge L2 and a top endpoint of the second edge L2, i.e., the support structure is arranged at a position adjacent to the top endpoint of the second edge L2. Generally speaking, a display device is slightly inclined forward in use, and through adjusting the position of the support structure, it is able to prevent the occurrence of the stress concentration.

In some embodiments of the present disclosure, the support structure is arranged along a straight line. In this way, a middle portion of the second edge L2, i.e. a portion in contact with the support structure, is also distributed along the straight line. The bending amount of the second edge L2 gradually increases in a direction away from the light-exiting surface of the curved display panel between each end of the support structure and the corresponding endpoint of the second edge L2, i.e., the depression amount of the second edge L2 increases gradually.

In some other embodiments of the present disclosure, a shape of the support structure is adjusted, e.g., the support structure is curved to some extent. Illustratively, in a possible embodiment of the present disclosure, in a direction from the middle point to each endpoint of the second edge L2, the bending amount of the second edge L2 gradually increases towards a side away from the light-exiting surface of the curved display panel, and the shape of the support structure matches the shape of the second edge L2, i.e., the support structure is slightly curved to form an arc-like shape. In this way, it is able for the support structure to be adapted to the shape of the second edge L2 which is depressed at the endpoints, thereby to further prevent the occurrence of the stress concentration, and improve a support effect for the second edge L2.

As shown in FIG. 13A, it is found through simulation that, the stress concentration of the optimized curved display panel is reduced, and the light leakage of the display panel is significantly improved as shown in FIG. 13B.

The present disclosure further provides in some embodiments a curved display panel, which includes a curved display panel whose curvature is determined by the above- mentioned curvature determination method.

The present disclosure further provides in some embodiments a curved display panel. A curvature W of a first edge L1 of the curved display panel in a first direction satisfies (14).

In some embodiments of the present disclosure, the second edge L2 of the curved display panel is supported by a support structure, the support structure abuts against the curved display panel at the second edge L2, the support structure extends from the center of the second edge L2 along the second edge L2 to each endpoint of the second edge L2, a maximum distance between the support structure and the center of the second edge L2 is 10% to 21% of the length of the second edge L2, and a total length of the support structure is 20% to 42% of the total length of the second edge L2.

Further, in some embodiments of the present disclosure, the maximum distance between the support structure and the center of the second edge L2 is 15% to 18% of the length of the second edge L2.

For example, a dimension of the support structure for supporting the second edge L2 is one third of the length of the second edge L2. For example, when the length of the second edge L2 is 360 mm, the support structure having a length of 120 mm is arranged in the middle of the second edge L2.

The present disclosure further provides in some embodiments a display device which includes the above-mentioned curved display panel.

The implementation of the display device may refer to that of the curvature determination method mentioned hereinabove with a same technical effect, and thus will not be particularly defined herein.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. A curvature determination method for a curved display panel, comprising:
establishing a first association relationship between deflection and a shear stress of the curved display panel in a first direction, the first direction being a bending direction of the curved display panel;
determining a constraint condition for the shear stress in accordance with an influence of the shear stress on a light leakage of the curved display panel; and
generating a curvature change relationship of the curved display panel in the first direction in accordance with the first association relationship when the constraint condition has been satisfied.

2. The curvature determination method according to claim 1, wherein the establishing the first association relationship between the deflection and the shear stress of the curved display panel in the first direction comprises:
obtaining a second association relationship between the shear stress and a cross-sectional shear force of the curved display panel in the first direction;
obtaining a third association relationship between the deflection and a bending moment of the curved display panel in the first direction;
obtaining a fourth association relationship among the deflection, the cross-sectional shear force and the bending moment of the curved display panel in the first direction; and
generating the first association relationship in accordance with the second association relationship, the third association relationship and the fourth association relationship.

3. The curvature determination method according to claim 2, wherein the constraint condition comprises that the shear stress is a constant.

4. The curvature determination method according to claim 1, wherein the curved display panel further comprises a second edge extending along a second direction, and the second direction intersects the first direction,
wherein the curvature determination method further comprises:
determining an initial stress distribution state of the second edge in accordance with the curvature change relationship;
determining a fitted shape of the second edge in accordance with the initial stress distribution state and a support mode of the second edge; and
determining a support parameter of the second edge in accordance with the fitted shape of the second edge.

5. The curvature determination method according to claim 4, wherein the determining the support parameter of the second edge in accordance with the fitted shape of the second edge comprises:
establishing a model of the curved display panel in accordance with the determined fitted shape;
determining a stress distribution state of the second edge in different support states through simulation; and
determining the support parameter of the second edge in accordance with the support state corresponding to a simulation result when the stress distribution state satisfies a preset stress distribution requirement.

6. The curvature determination method according to claim 4, wherein the support parameter comprises a support position and a support length for the second edge.

7. The curvature determination method according to claim 4, wherein the fitted shape comprises an arc-like shape.

8. A curved display panel having a curvature determined through the curvature determination method according to claim 1.

9. A display device, comprising the curved display panel according to claim 8.

10. A curved display panel, wherein a curvature w of a first edge of the curved display panel in a first direction satisfies w=k₁x³+k₂x, 0≤x≤L/2, and w=−k₁(x−L)³−k₂(x−L), L/2<x≤L, where
$${k}_{1} = \frac{- 8 {w}_{max}}{2 {L}^{3}} , {k}_{2} = \frac{3 {w}_{max}}{L} ,$$
L is a dimension of the curved display panel along the first direction, wₘₐₓ is a maximum deflection value of the curved display panel, and the first direction is a bending direction of the curved display panel

11. The curved display panel according to claim 10, wherein the curved display panel further comprises a second edge extending along a second direction, and the second direction intersects the first direction, wherein a curvature w₁ of the second edge satisfies w₁=\sqrt{R²−(y−O₂)²}−O₁, where R is a radius, and O₁ and O₂ are each coordinates of a center of a circle.

12. The curved display panel according to claim 11, further comprising a second edge extending along a second direction, wherein the second direction intersects the first direction, and both ends of the second edge are bent toward a side away from a light-exiting surface of the curved display panel.

13. The curved display panel according to claim 12, wherein two endpoints of the second edge are bent with respect to a middle point of the second edge by 0.4 mm to 1.5 mm.

14. The curved display panel according to claim 10, further comprising a support structure abutting against the second edge of the curved display panel, wherein a middle point of the second edge is arranged in a region where the support structure abuts against the second edge, and a length of the support structure is 20% to 42% of a length of the second edge.

15. The curved display panel according to claim 14, wherein the length of the support structure is 30% to 36% of the length of the second edge.

16. The curved display panel according to claim 14, wherein a middle point of the support structure corresponds to the middle point of the second edge, and the support structure is arranged symmetrically relative to a central axis of the second edge.

17. The curved display panel according to claim 14, wherein the middle point of the support structure is located between the middle point of the second edge and a top endpoint of the second edge.

18. The curved display panel according to claim 14, wherein the second edge extends along a straight line in the region where the support structure abuts against the second edge; and/or a bending amount of the second edge toward a side away from a light-exiting surface of the curved display panel gradually increases between each of two ends of the support structure and a corresponding endpoint of the second edge.

19. The curved display panel according to claim 14, wherein a bending amount of the second edge gradually increases toward a side away from a light-exiting surface of the curved display panel in a direction from the middle point of the second edge to each endpoint of the second edge, and a shape of the support structure matches a shape of the second edge.

20. The curvature determination method according to claim 5, wherein the support parameter comprises a support position and a support length for the second edge.
